(19) United States
(12) Patent Application Publication
(10) Pub. No.: US 2017/0174212 A1
(43) Pub. Date: Jun. 22, 2017

(54) METHOD FOR OPERATING A MOTOR VEHICLE

(71) Applicant: FORD GLOBAL TECHNOLOGIES, LLC, Dearborn, MI (US)

(72) Inventors: Uwe GUSSEN, Huertgenwald NRW (DE); Frederic STEFAN, Aachen NRW (DE); Christoph ARNDT, Moerlen Rheinland-Pfalz (DE)

(73) Assignee: FORD GLOBAL TECHNOLOGIES, LLC, Dearborn, MI (US)

(21) Appl. No.: 15/378,703

(22) Filed: Dec. 14, 2016

(30) Foreign Application Priority Data
Dec. 18, 2015 (DE) 10 2015 226 049.6

(51) Int. Cl. B60W 30/09; G08G 1/16; B60W 10/30; B60W 50/14; B60W 30/095; B60W 10/18

(52) U.S. Cl. CPC B60W 30/09; B60W 30/0956; B60W 10/18; B60W 10/30; B60W 50/14; G08G 1/162; B60W 2050/143; B60W 2540/12

(57) ABSTRACT

The disclosure relates to a method for operating a first motor vehicle, in which rear sensor values are captured from a second motor vehicle following the first motor vehicle. A brake pedal of the first motor vehicle is monitored for actuation. A risk value for a rear end collision is determined in response to detected actuation by evaluating the captured sensor values. The risk value determined is compared with a threshold value, and an alarm signal is generated in response to the threshold value being exceeded.

### CROSS-REFERENCE TO RELATED APPLICATIONS

This application claims foreign priority benefits under 35 U.S.C. §119(a)-(d) to DE 10 2015 226 049.6 filed Dec. 18, 2015, which is hereby incorporated by reference in its entirety.

### TECHNICAL FIELD

The disclosure relates to a method for operating a first motor vehicle, in which sensor values are captured from a second motor vehicle following the first motor vehicle.

### BACKGROUND

Dangerous situations result again and again at traffic lights or at ends of traffic jams in motor vehicle traffic. A motor vehicle driver usually looks forward and also habitually looks in the rearview mirror during braking. This also applies in the case of emergency braking operations at traffic lights or at ends of traffic jams. The motor vehicle driver automatically adapts to the environment and the traffic situation in order to avoid a rear end collision or dangerous situations. For example, the motor vehicle driver actuates the brakes a few milliseconds later, reduces the brake pressure or accelerates depending on the traffic situation in the direction of travel in front of his motor vehicle and in the direction of travel behind him.

EP 1 852 323 A1 discloses a system for a motor vehicle, in which a relative speed between a motor vehicle traveling in front and a following motor vehicle is captured and the brakes of the motor vehicle traveling in front are activated after the relative speed has been evaluated.

U.S. Pat. No. 8,731,815 B2 discloses a motor vehicle in which a sensor is used to detect the risk of a rear end collision and the tail lights of the motor vehicle are activated in order to warn following motor vehicles in response to a minimum danger level being exceeded.

Therefore, there is a need to increase the traffic safety at traffic lights and/or ends of traffic jams.

### SUMMARY

The object of the disclosure is achieved by means of a method for operating a first motor vehicle, in which rear sensor values are captured from a second motor vehicle following the first motor vehicle. For this purpose, a brake pedal of the first motor vehicle is monitored for actuation, a risk value for a rear end collision is determined in response to detected actuation by evaluating the captured sensor values, the risk value determined is compared with a threshold value, and an alarm signal is generated in response to the threshold value being exceeded. Safety systems of the motor vehicle are therefore activated only when there is brake pedal actuation by the motor vehicle driver. This reduces the risk of incorrect intervention by driver assistance systems in traffic situations in which the brake pedal has not been actuated at all and such intervention is not necessary. Furthermore, no C2C communication is required, which makes the method independent of the presence of radio connections for interchanging data. In addition, such a reaction by the motor vehicle driver can be taken into account, which complies with the desire of a motor vehicle driver to control his motor vehicle.

According to one embodiment, the brake pedal actuation is detected using a foot well camera and the sensor values are captured in response to brake pedal actuation being detected. The sensors are therefore activated in a targeted manner and their measured values are read, which saves the computer capacities of driver assistance systems. Evaluating image data from a foot well camera makes it possible to detect actions of the motor vehicle driver in good time before they become effective by depressing the brake pedal, with the result that an increased period is available for a reaction. Alternatively, actuation of the brake pedal can also be detected directly, for example using a potentiometer on the brake pedal.

According to another embodiment, a maximum braking distance of the following second motor vehicle is determined from the sensor values in order to determine the risk value. For this purpose, the distance, the speed and the length of time to a rear end collision are captured or determined as sensor values. The sensor data themselves may come from a radar, a lidar or another measuring device.

According to another embodiment, the alarm signal is output acoustically and/or optically. The alarm signal is therefore immediately brought to the attention of the motor vehicle driver.

According to another embodiment, monitoring for a reaction from the motor vehicle driver is carried out in response to the alarm signal being output and a brake deactivation signal for releasing the brakes of the first motor vehicle is generated in response to an absence of a reaction. The monitoring for an absence of a reaction is carried out for a predetermined length of time, which is oriented to the normal reaction time of motor vehicle drivers. Safety is, therefore, also increased in situations in which a reaction from the motor vehicle driver is absent.

According to another embodiment, a brake deactivation signal for releasing the brakes of the first motor vehicle is generated in response to the alarm signal. The brakes of the motor vehicle are automatically released with the brake deactivation signal. This reduces the consequences of a possible rear end collision.

According to another embodiment, the brake deactivation signal is suppressed if the detected traffic situation has been classified as unsuitable. The traffic situation can be detected, for example, using a sensor system that is oriented in the direction of travel of the motor vehicle and has, for example, a camera having a traffic sign recognition system. The detected traffic situation is classified as unsuitable if there are obstacles in the direction of travel of the motor vehicle and it can therefore be expected that these obstacles will cross the route of the motor vehicle.

According to another embodiment, the motor vehicle is moved by a predetermined travel distance in the direction of travel in response to the alarm signal. For this purpose, in addition to releasing the brakes, the engine and the transmission of the motor vehicle are also accordingly activated. The travel distance is calculated according to the conventional distance between two motor vehicles that are behind one another at a traffic light or in a traffic jam. For example, the travel distance may be less than one meter. The motor vehicle may travel forward by this travel distance in order to therefore avoid a rear end collision or reduce its consequences without itself causing a rear end collision.

According to another embodiment, the risk value determined is compared with a second threshold value, which is greater than the first threshold value, and the motor vehicle is moved by a greater travel distance in the direction of travel in response to the second threshold value being exceeded than when the first threshold value is exceeded. It is therefore possible to provide an even greater distance in order to avoid a rear end collision or to reduce its consequences.

According to another embodiment, road conditions are detected and are taken into account when determining the risk value. The road conditions may be wetness, snow, ice or areas of water that cause aquaplaning. These conditions can be taken into account, for example, when determining the maximum braking distance by means of corresponding weight factors.

According to another embodiment, a front sensor system of the first motor vehicle is used to capture and evaluate front sensor data. Information relating to the traffic situation in the direction of travel of the first motor vehicle is therefore available and further options for action can be selected depending on the detected traffic situation, for example traveling forward to a free intersection in order to reduce the consequences of a rear end collision or avoid the latter.

According to another embodiment, the front sensor system is used to capture and evaluate traffic light signals and a driving signal is generated on the basis of a detected traffic light signal. A traffic sign recognition system can be used to detect traffic light signals. For example, as already described, the traffic situation in the direction of travel is detected in response to amber being detected. If evaluation of the traffic situation by means of an intersection assistant, for example, reveals that there is no risk of intersection traffic, for example, the driving signal is generated and causes the motor vehicle to move toward the intersection or beyond the intersection in order to avoid a rear end collision or reduce its consequences.

The disclosure also includes a motor vehicle having a pedal actuation detection device for detecting actuation of a brake pedal of the motor vehicle, a sensor assembly for capturing sensor values from a second motor vehicle following the first motor vehicle, and an evaluation device for evaluating the captured sensor values in order to determine a risk value for a rear end collision, for comparing the determined risk value with a threshold value and for generating an alarm signal in response to the threshold value being exceeded.

The disclosure is now explained using a drawing, in which:

### BRIEF DESCRIPTION OF THE DRAWINGS

FIG. 1 shows an accident scenario, and

FIG. 2 shows a schematic illustration of an exemplary embodiment of a motor vehicle which is designed to carry out a method according to the disclosure, and

FIG. 3 shows a schematic flowchart of an exemplary embodiment of a method according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

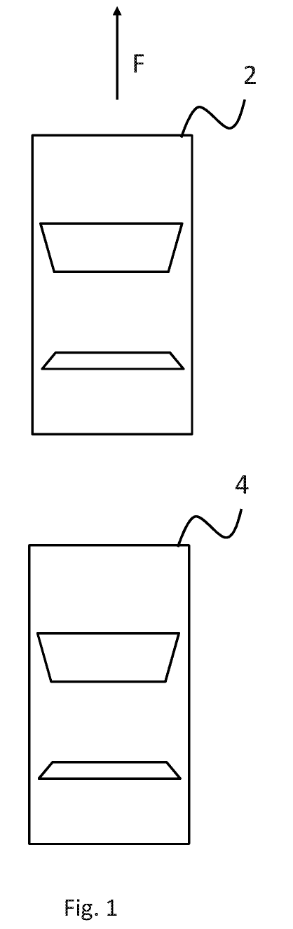

Reference is first of all made to FIG. 1.

In the traffic situation illustrated in FIG. 1, a first motor vehicle 2 is at a traffic intersection with traffic lights, for example. Alternatively, the first motor vehicle 2 may also be at the end of a traffic jam. In both cases, the first motor vehicle 2 is stationary and is held by the motor vehicle driver by actuating the brake pedal. Furthermore, the first motor vehicle 2 may also still be moving, that is to say the first motor vehicle 2 moves toward a traffic intersection with a red traffic light or moves toward the end of a traffic jam, for example.

On account of the second motor vehicle 4 following the first motor vehicle 2, there is the risk of a rear end collision in this traffic situation. It is noted that the first motor vehicle 2 and the second motor vehicle 4 have substantially the same direction of travel F, which is understood as being substantially within deviations that are conventional during operation of motor vehicles.

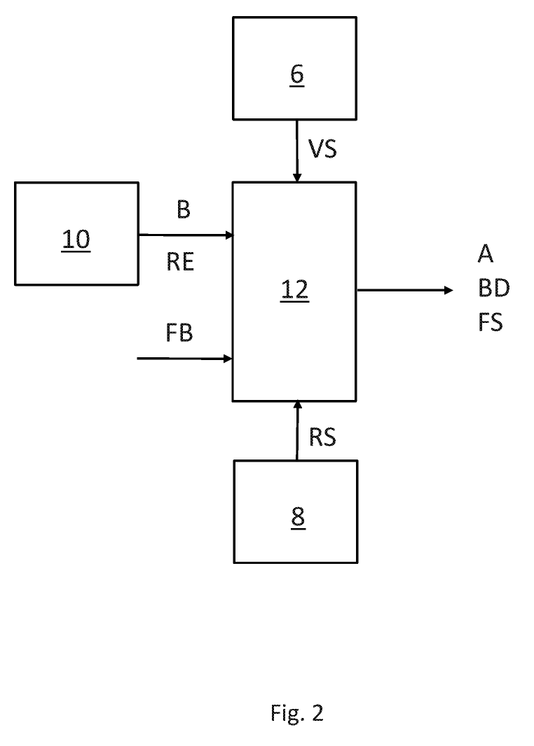

Reference is now additionally made to FIG. 2.

Various components of the first motor vehicle 2 are illustrated.

The illustrated components are a front sensor system 6, a rear sensor system 8, a pedal actuation detection device 10 and an evaluation device 12.

Whereas the front sensor system 6 is designed to capture data relevant to the traffic situation in the direction of travel F and is therefore oriented in the direction of travel F, the rear sensor system 8 is designed to capture data relevant to the traffic situation counter to the direction of travel F and is therefore oriented counter to the direction of travel F. For this purpose, the front sensor system 6 and the rear sensor system 8 may each have different sensors, for example radar or lidar sensors, and, for example, cameras, for example charge-coupled device (CCD) cameras. In particular, a traffic sign recognition means is connected to the front sensor system 6 and can be used to detect and evaluate light signals from a traffic light, for example. Furthermore, the front sensor system 6 can be used to detect and evaluate the traffic situation at an intersection, for example. In contrast, the rear sensor system 8 can be used to detect the traffic situation in the direction of travel F behind the first motor vehicle 2. In particular, the rear sensor system 8 can be used to determine the distance and the speed and the length of time to a rear end collision. In particular, the rear sensor system 8 may be assigned a camera of a rearview mirror system or of a rearview camera.

The pedal actuation detection device 10 is designed to detect actuation B of the brake pedal by the motor vehicle driver. In the present exemplary embodiment, a camera, for example a CCD camera, is provided in the foot well for this purpose. An actuated brake pedal or intended actuation of the brake pedal by the motor vehicle driver is detected by evaluating the image data provided by the camera.

The evaluation device 12 is designed to determine a risk value R for a rear end collision by evaluating the sensor values RS captured using the rear sensor system 8, to compare the determined risk value R with a first threshold value SW1 and to generate an alarm signal A in response to the threshold value being exceeded.

For this purpose, the evaluation device 12 is designed to first determine the risk value R for a rear end collision in response to detected actuation B. For this purpose, the evaluation device 12 reads in the rear sensor values RS captured by the rear sensor system 8—in the present exemplary embodiment, the distance and the speed of the second motor vehicle 4 and the length of time to a rear end collision by the second motor vehicle 4.

The evaluation device 12 is also designed to read in captured values for road conditions FB and to take them into account when determining the risk value R. The road conditions FB may be, for example, wetness, snow, ice or areas of water causing aquaplaning, which are taken into account when determining the maximum braking distance by means of corresponding weight factors. The evaluation device 12 is also designed to output the alarm signal A acoustically and/or optically in order to immediately bring the alarm signal A to the attention of the motor vehicle driver. A corresponding human-machine interface (HMI) may be provided for this purpose and also provides the motor vehicle with detailed information, for example handling instructions.

The evaluation device 12 is also designed to monitor the motor vehicle driver for a reaction RE to the alarm signal A for a predetermined length of time beginning with the output of the alarm signal A. Monitoring is carried out in order to determine whether the motor vehicle driver does not actuate the brake pedal in response to the alarm signal A, that is to say there is no actuation B. If the predetermined length of time elapses without a reaction from the motor vehicle driver to the alarm signal A, a brake deactivation signal BD for releasing the brakes of the first motor vehicle 2 is generated.

The brake deactivation signal BD automatically releases the brakes of the motor vehicle and thus reduces the consequences of a possible rear end collision. Provision may also be made for the first motor vehicle 2 to be moved by a predetermined travel distance in the direction of travel F in response to the alarm signal A. For this purpose, in addition to releasing the brakes, the engine and the transmission of the first motor vehicle 2 are also accordingly activated. Since the travel distance is calculated according to the conventional distance between two motor vehicles that are behind one another at a traffic light or in a traffic jam, the first motor vehicle 2 can travel forward by this travel distance in the direction of travel F in order to thus avoid a rear end collision or reduce its consequences without itself causing a rear end collision.

The evaluation device 12 is also designed to read in and evaluate front sensor data VS from the front sensor system 6 in order to assess the traffic situation in the direction of travel F of the first motor vehicle 2. The detected traffic situation is classified as unsuitable by an intersection assistant, for example, if there are obstacles in the direction of travel F of the first motor vehicle 2 and it can therefore be expected that these obstacles will cross the route of the first motor vehicle 2. In this case, the evaluation device 12 suppresses the brake deactivation signal BD.

The evaluation device 12 is also designed to compare the determined risk value R with a second threshold value SW2. The second threshold value SW2 is greater than the first threshold value SW1 and indicates a rear end collision by the second motor vehicle 4, which cannot be certainly prevented. In order to reduce the consequences of the rear end collision, the evaluation device 12 generates a driving signal FS for releasing the brakes and for activating the engine and the transmission.

The first motor vehicle 2 is therefore moved by a greater travel distance in the direction of travel F in response to the second threshold value SW2 being exceeded than when the first threshold value SW1 is exceeded in order to therefore provide an even greater distance for the purpose of reducing the consequences of the rear end collision.

Finally, the evaluation device 12 is also designed in this constellation to read in and evaluate sensor data VS from the front sensor system 6 in order to assess the traffic situation in the direction of travel F of the first motor vehicle 2. For example, the evaluation device 12 detects and evaluates traffic light signals. For example, as already described, the traffic situation in the direction of travel F is detected in response to amber being detected. If evaluation of the traffic situation by an intersection assistant, for example, reveals that there is no risk of intersection traffic, for example, the driving signal FS is generated and causes the first motor vehicle 2 to move toward the intersection or beyond the intersection in order to avoid a rear end collision or reduce its consequences.

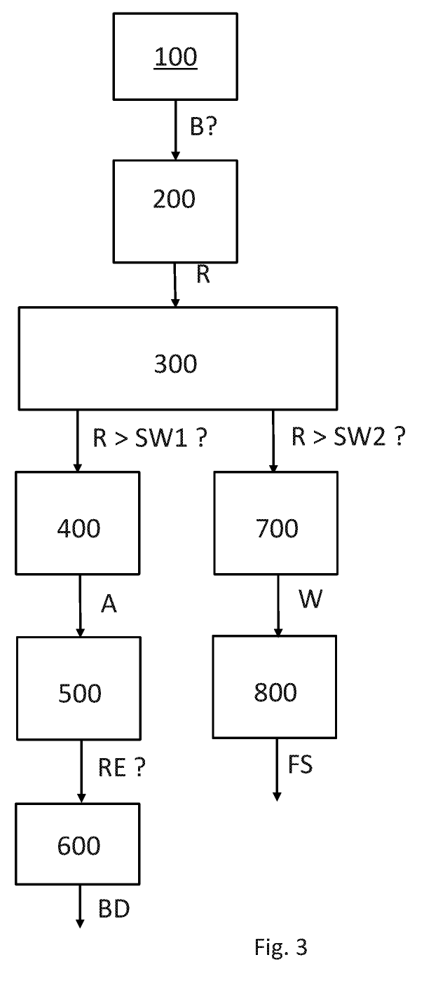

The sequence of an exemplary embodiment of a method according to the disclosure is explained with additional reference to FIG. 3.

During operation, the pedal actuation detection device 10 monitors continuously in a first step 100 whether the motor vehicle driver actuates the brake pedal and the actuation B is therefore present.

In a second step 200, the evaluation device 12 reads in the sensor data RS from the rear sensor system 10 and the road conditions FB in response to the detected actuation B and determines the risk value R.

In a third step 300, the evaluation device 12 compares the determined risk value R with the first threshold value SW1 and the second threshold value SW2.

In a fourth step 400, the alarm signal A is output in response to the first threshold value being exceeded.

Furthermore, in a fifth step 500, the monitoring for the reaction RE from the motor vehicle driver, namely release of the brake pedal by the motor vehicle driver, begins.

In a sixth step 600, the brake deactivation signal BD for releasing the brakes of the first motor vehicle 2 is generated in response to the absence of the reaction RE, in response to which signal the motor vehicle is moved by a predetermined travel distance of less than 1 meter, for example, in the direction of travel F.

Alternatively, provision may also be made for the brake deactivation signal BD to be automatically generated in the fourth step 400. The traffic situation in the direction of travel F of the first motor vehicle 2 is then detected and evaluated. If the detected traffic situation has been classified as unsuitable, the brake deactivation signal BD is suppressed in order to prevent rolling forward into a danger zone.

If the comparison of the determined risk value R with the first threshold value SW1 and the second threshold value SW2 in the third step 300 reveals that the risk value R is greater than the second threshold value SW2, the method is continued with a seventh step 700 in which the front sensor assembly 6 is used to detect and evaluate traffic light signals, for example, in order to determine whether an onward journey W is possible without the risk of an accident.

If the traffic situation allows this, the driving signal FS is generated in order to move the first motor vehicle 2 by a greater travel distance in the direction of travel F than when the first threshold value SW1 is exceeded.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for operating a first vehicle comprising:
capturing rear sensor values from a second vehicle following the first vehicle;
monitoring a brake pedal of the first motor vehicle for actuation;
determining a risk value for a rear end collision in response to detected actuation by evaluating the captured sensor values;
comparing the risk value with a threshold value; and
generating an alarm signal in response to the threshold value being exceeded.

2. The method as claimed in claim 1, further comprising detecting the actuation using a foot well camera, wherein and the sensor values are captured in response to the actuation being detected.

3. The method as claimed in claim 1 further comprising:
determining a maximum braking distance of the following second vehicle from the sensor values to determine the risk value.

4. The method as claimed in claim 1, wherein generating the alarm signal is output acoustically and/or optically.

5. The method as claimed in claim 1 further comprising:
monitoring for a reaction from a driver in response to the alarm signal being output, and, in an absence of the reaction, generating a brake deactivation signal for releasing the brakes of the first vehicle.

6. The method as claimed in claim 1 further comprising:
generating a brake deactivation signal for releasing the brakes of the first vehicle in response to the alarm signal.

7. The method as claimed in claim 6 further comprising:
suppressing the brake deactivation signal responsive to a detected traffic situation being classified as unsuitable.

8. The method as claimed in claim 1 the first vehicle and the second vehicle are facing in a direction of travel, further comprising:
moving the first vehicle by a predetermined travel distance in the direction of travel in response to the alarm signal.

9. The method as claimed in claim 8 further comprising:
comparing the risk value with a second threshold value greater than the threshold value, and, in response to the second threshold value being exceeded, moving the first vehicle by a second travel distance in the direction of travel, the second travel distance being greater than the predetermined travel distance.

10. The method as claimed in claim 1, wherein determining the risk value includes detecting and accounting for road conditions.

11. The method as claimed in claim 1 further comprising:
capturing and evaluating front sensor data using a front sensor system of the first vehicle.

12. The method as claimed in claim 11 further comprising:
capturing and evaluating traffic light signals with the front sensor system and, in response to a detected traffic light signal, generating a driving signal.

13. A vehicle comprising:
a pedal actuation detection device configured to detect actuation of a brake pedal;
a rear sensor assembly configured to capture sensor values from a second vehicle following a first vehicle; and
an evaluation device configured to determine a risk value for a rear end collision based on the captured sensor values, compare the determined risk value with a threshold value, and, in response to the threshold value being exceeded, generate an alarm signal.

14. The vehicle of claim 13 further comprising a front sensor assembly configured to capture traffic light signals such that the evaluation device, in response to a detected traffic light signal, is configured to generate a driving signal.

15. The vehicle of claim 14, wherein the evaluation device is further configured to, in response to the driving signal, move the first vehicle by a predetermined travel distance in a direction of travel.

16. The vehicle of claim 13, wherein the captured sensor values include detected road conditions to determine the risk value.

17. The vehicle of claim 13, wherein the evaluation device is further configured to compare the risk value determined with a second threshold value greater than the threshold value, and, in response to the second threshold value being exceeded, move the first vehicle by a predetermined travel distance in a direction of travel.

18. A control system for a vehicle comprising:
an evaluation device configured to, in response to a risk value, based on captured sensor values from a second vehicle following a first vehicle, exceeding a threshold and a brake pedal actuation determined from the captured sensor values, generate an alarm signal.

19. The control system of claim 18, wherein the evaluation device is further configured to, in response to the alarm signal being output, monitor a reaction of a driver and, in an absence of the reaction, generate a brake deactivation signal to release the brakes of the first vehicle.

20. The control system of claim 18, wherein the evaluation device is further configured to, in response to the alarm signal being output, move the vehicle by a predetermined travel distance in a direction of travel.
